(19) United States
(12) Patent Application Publication
(10) Pub. No.: US 2004/0035258 A1
(43) Pub. Date: Feb. 26, 2004

(54) Valve wrench

(76) Inventor: Samuel Spector, Edison, NJ (US)

Correspondence Address: Samuel Spector, 14 Brookfall Road, Edison, NJ, 08817, US

(21) Appl. No.: 10/224,166

(22) Filed: Aug. 20, 2002

(51) Int. Cl. B25B 13/04

(52) U.S. Cl. 81/120

(57) ABSTRACT

A valve wrench for turning an elliptically shaped valve handle having a top surface and a rim includes a valve cap to be mounted over the valve handle. The valve cap has a top portion including top and bottom surfaces and a skirt depending in a generally perpendicular direction from the bottom surface. The bottom surface and the side of the skirt proximal to the bottom surface define an internal cavity shaped to fit over the top surface and around the rim of the valve handle. A shaft extends from the center of the top surface of the top portion of the valve cap and a torsion bar is coupled to the end of the shaft, distal from the center of the valve cap, for turning the valve cap and any valve handle over which the valve cap is placed

### BACKGROUND OF THE INVENTION

This invention relates to a novel valve wrench for opening and closing valves designed to pass liquids.

By way of example, valves for controlling the passage of fluids in water lines for plumbing fixtures (e.g., sinks, toilets, etc.) include a closing mechanism operated by a small valve handle, generally oval in shape, designed to be rotated by hand to open or close the valve mechanism. These valves are often very difficult to open or close, particularly when not used for a long period of time. The use of known wrenches to open and close these valves is generally not helpful because they do not grip the valve handle securely and tend to slip off.

Another problem with trying to open and close the valves is that they are often located in places which are not easy to reach, so it is difficult to apply the necessary force and torque to turn the valve handle.

It is an object of the invention to provide a novel valve wrench which overcomes the problems discussed above.

### SUMMARY OF THE INVENTION

Apparatus embodying the invention includes a valve wrench for turning a valve handle having an oblong or oval shape. The valve wrench includes a valve cap having an internal cavity shaped to generally to fit over the valve handle. The valve cap includes a top portion with generally parallel inner and outer surfaces and a skirt dependent generally perpendicularly from the top portion also with generally parallel inner and outer surfaces. The cavity (i.e., the internal surfaces of the top portion and the skirt) of the valve cap is shaped to fit over and around the valve handle so as to provide a turning force to the valve handle when a turning torque is applied to the valve cap. Means for turning the valve cap are connected to the outer surface of the top portion.

In one embodiment, the means for turning the valve cap include a shaft which is fixedly and permanently connected to the outer surface of the top portion in order to turn the valve cap. In another embodiment a central portion of the top portion is cut out and a shaft is provided which may be selectively inserted into the cut out. The shaft has one end shaped to fit snuggly within the cut out and another end for applying a turning force to the shaft. The shaft may be part of a ratchet wrench used to turn the valve cap when it is mounted on top of a valve handle.

### BRIEF DESCRIPTION OF THE DRAWINGS

In the accompanying drawing like reference characters denote like components; and

FIG. 1 is a perspective view of a valve and a valve wrench embodying the invention for turning the valve handle;

FIG. 2 is a front view of the inside of a valve wrench embodying the invention;

FIG. 3 is a cross-sectional diagram of the valve cap of FIG. 2, taken along line 3-3;

FIG. 4 is a cross-sectional diagram of a valve cap embodying the invention mounted on a valve handle; and

FIG. 5 is an isometric view of a valve wrench embodying the invention.

### DETAILED DESCRIPTION

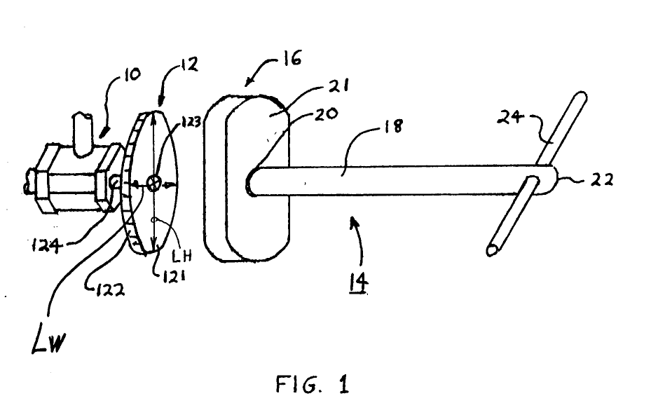

Referring to FIG. 1, there is shown an isometric of a valve 10 and a valve handle 12 which is turned clockwise or counterclockwise to shut or open the valve 10 and block or allow a liquid to pass through the valve. The valve handle 12 has an external face 121 and an external rim 122 and is securely attached by a screw 123 to a rotating shaft 124 whose rotation controls the flow of fluids through the valve. The object of the invention is to have a tool which can be used to more easily turn the valve handle.

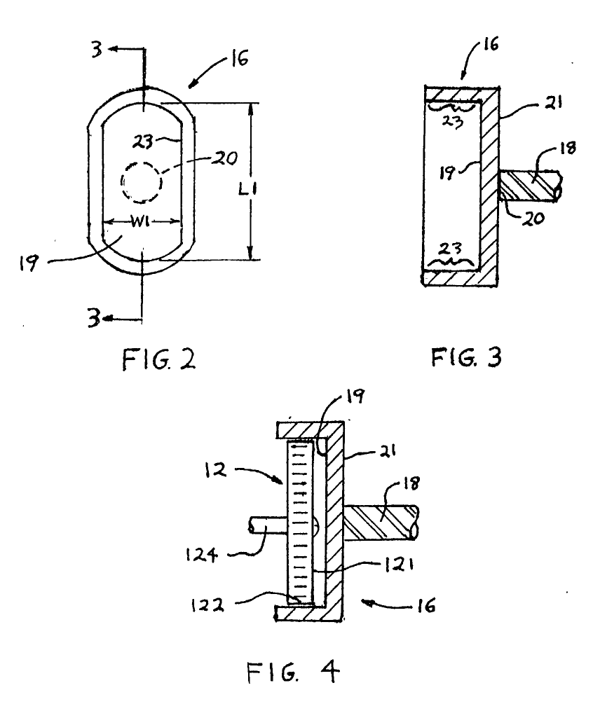

FIG. 1 shows a valve wrench 14 embodying the invention which includes a valve-cap 16, having an internal cavity (see FIGS. 2-5) whose internal surfaces are shaped to fit over valve handle 12 so as to enable handle 12 to be turned in either direction. The valve wrench 14 also includes a shaft 18 having one end welded to the center 20 of the external portion of the valve cap. The shaft 18 extends from the center of the top portion of the valve cap and, at its distal end 22, a hole is formed through which a torsion bar 24 may be inserted for applying sufficient torque to the shaft 18 to turn the valve cap 16 and the valve handle 12 nested within the valve cap.

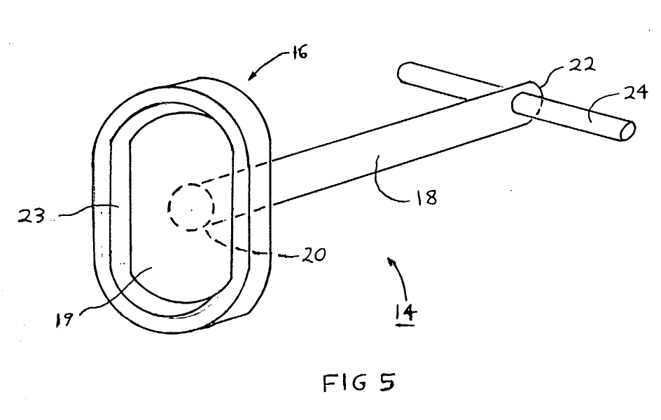

FIG. 2 is a view looking into the cavity of the valve cap which is intended to fit over the valve handle 12. FIG. 3 is a cross section of a portion of the valve cap 16 and shaft 18. FIG. 4 is a cross-sectional diagram of a valve cap 16 mounted on a valve handle 12. In FIG. 2 the inner portion of the valve cap 16 is shown to be of a generally oval or elliptical shape to fit over the top surface 121 of the valve handle and around the outer rim 122 of the valve handle 12. The inner cavity of the valve cap is dimensioned so that when the valve cap is turned it will “grab” the walls or rim 122 of the valve handle.

In general, the inner cavity of the valve cap may have any oblong shape (i.e., it may be rectangular or elliptical) with an inner width “W1” and an inner length “L1”, as shown in FIG. 2. In order to have the tool perform its intended function of turning a valve handle, it is only necessary that the shortest dimension “W1” (see FIG. 2) of the valve cap be shorter than the longest dimension “LH” of the valve handle (see FIG. 1 where the longest dimension LH of the valve handle is greater than the dimension of the width LW); and that L1 be greater than LH. Thus, when the valve cap is turned there is a firm contact between at least two points of the internal cavity of the valve cap and the rim of the valve handle 12.

In the embodiments shown in the figures, the inner or internal surface 19 of the top portion of the valve cap is generally flush with the external surface 121 of the valve handle 12. The valve cap has a top external surface 21 generally parallel to the inner surface 19 and a “skirt” or overhang 23 which extends in a generally perpendicular direction to the edge of the top surface 21 and defines the cavity which is designed to fit around the rim 122 of the valve handle 12. The length or depth of the skirt 23 is such that it extends for the width or depth of the rim 12. The length (depth) of the skirt may be longer than the width of the rim 122 to provide good “gripping” action. In the description to follow and in the appended claims, the “skirt” of the valve cap refers to that portion of the valve cap extending generally in a perpendicular direction from and along the edge of the top surface to define a cavity intended to fit around the rim of the valve handle.

Extending from the center 20 of the top outer surface is a solid, rigid, shaft 18. The length of the shaft 18 may range from 6 inches to 12 or more inches to ensure that there is clearance to any object surrounding the valve handle. The torsion bar 24 can be used to apply sufficient torque via shaft 18 to the valve cap 16 to turn the valve handle 12 in a desired direction. FIG. 5 is an isometric view of the valve wrench embodying the invention looking into the inner surface portion of the valve cap. In FIGS. 2-5 the shaft 18 may be welded to the top portion of cap 16. However, any other suitable means of securely and permanently fixing the shaft to the top of valve cap may also be used.

The wrench 14 may be formed of solid rigid materials (e.g., metals such as aluminum, iron or steel or any hard plastic) which can be used to turn a valve handle without “give” and which enable the torque applied to the distal shaft end to be transferred to the valve cap and the valve handle.

In the figures the shaft 18 is fixedly connected to the center top of the valve cap to form a unitary and integral tool. This is done to ensure that the valve cap and shaft function as a unitary solid and rigid tool providing maximum transfer of any force exerted on the tool. However, it should be appreciated that the center of the valve cap and the shaft may be manufactured as two separate units. In this case a groove (shaped cut out) would be formed in the center of the top portion (or at any other desired location) and at least one end of the shaft would be shaped so as to fit into the groove and provide a firm and solid coupling to turn the valve cap and any valve handle over which it is mounted the shaft 180 may be selected to be short or long depending on the desired clearance surrounding the valve handle. The use of valve caps with a central cut out enables the placement of the cap over the valve handle and the subsequent insertion of a shaft into the central cut out.

The shape of the valve cap has been shown to be oval but any suitable shape (e.g., even a rectangle) may be used.

What is claimed is:

1. A valve wrench for turning an elliptically shaped valve handle having a top surface and a rim comprising:
a valve cap to be mounted over the valve handle; the valve cap having a top portion including top and bottom surfaces and a skirt depending in a generally perpendicular direction from the bottom surface; the bottom surface and the internal side of the skirt defining an internal cavity shaped to fit over the top surface and around the rim of the valve handle;
a shaft extending from the center of the top surface of the top portion of the valve cap; and
means coupled to the shaft for turning the valve cap and a valve handle over which the valve cap is placed.

2. The valve wrench as claimed in claim 1, wherein the means coupled to the shaft for turning the valve cap includes a torsion bar attached to the end of the shaft distal from the center of the valve cap; and wherein the shaft and the valve cap define a solid rigid structure such that the torque applied to the distal end of the shaft is transferred to the valve cap and the valve handle.

3. The valve wrench as claimed in claim 1, wherein the valve cap and the shaft are formed as a rigid unitary tool.

4. The valve wrench as claimed in claim 1, wherein the internal cavity of the valve cap is elliptical.

5. The valve wrench as claimed in claim 1 wherein the longest dimension of the top surface of the valve handle is “LH”; and wherein the internal cavity of the valve cap intended to be mounted over the valve handle has width and length dimensions which may expressed as “W1” and “L1”, respectively, where W1 is the smallest dimension; and wherein W1 is selected to be smaller than LH, and L1 is larger than LH.

6. The valve wrench as claimed in claim 1, wherein the valve cap has an opening in the center thereof for the insertion of a shaft; and wherein the shaft is inserted into the opening.

7. A valve wrench for turning an elliptical valve handle comprising:
a valve cap having an inner portion shaped to fit over and snuggly around the valve handle; said valve cap having an outer portion with a surface generally parallel to the inner surface;
a cut out in the center of the valve cap; said cut out shaped to accept a stub which when inserted into the cut out can cause the valve cap to turn;
a stub having one end shaped to be inserted into the cut out; and means coupled to the stub for causing the stub and the valve cap to turn.

8. A wrench for turning a valve handle comprising:
an oblong shaped valve cap comprising a top portion having generally parallel top and bottom surfaces and a skirt depending in a generally perpendicular direction from the bottom surface along the edge thereof, the bottom surface and the skirt defining an internal cavity; and
a shaft extending from the top surface of the top portion of the valve cap for selectively turning the valve cap.

9. A wrench as claimed in claim 8, wherein the valve handle has top surface whose longest dimension is “LH”; and wherein the internal cavity of the valve cap intended to be mounted over the valve handle has width and length dimensions which may expressed as “W1” and “L1”, respectively, where W1 is the smallest dimension; and wherein W1 is selected to be smaller than LH, and L1 is larger than LH.
